(19) United States
(12) Patent Application Publication
(10) Pub. No.: US 2002/0046085 A1
(43) Pub. Date: Apr. 18, 2002

(54) SYSTEM AND METHOD FOR DELIVERING TARGETED PRODUCT SAMPLES AND MEASURING CONSUMER ACCEPTANCE VIA A COMPUTER NETWORK

(76) Inventors: DAVID ROCHON, WESTPORT, CT (US); THOMAS MURRAY, RIDGEFIELD, CT (US)

Correspondence Address: OBLON SPIVAK MCCLELLAND, MAIER & NEUSTADT PC, 1755 JEFFERSON DAVIS HIGHWAY 4TH FLOOR, ARLINGTON, VA, 22202

(21) Appl. No.: 09/418,509

(22) Filed: Oct. 15, 1999

Related U.S. Application Data
(60) Provisional application No. 60/133,364, filed on May 10, 1999.
(60) Provisional application No. 60/136,791, filed on May 28, 1999.

(51) Int. Cl. G06F 17/60

(52) U.S. Cl. 705/14

(57) ABSTRACT

A computer network implemented method and system for distributing product samples to users and monitoring user feedback including transmitting a signal prompting a user to provide profile data including identification of the user from a main computer over a computer network to a network address for the user's computer; transmitting the manufacturer's sample offer from the main computer over the computer network to the network address for the user's computer if the user's profile data meets criteria associated with a manufacturer's sample offer for a sample of a product; and delivering the sample of the product to an address for the user if the main computer receives a signal transmitted over the computer network indicating the user accepts the manufacturer's sample offer.

### CROSS-REFERENCE TO RELATED APPLICATIONS

This application claims benefit of priority under 35 U.S.C. 119(e) from provisional patent application No. 60/133,364 filed on May 10, 1999 and provisional patent application No. 60/136,791 filed May 28, 1999.

### BACKGROUND OF THE INVENTION

1. Field of the Invention

The present invention relates generally to product marketing and more particularly to a system and method for delivering product samples to consumers.

2. Discussion of the Background

Product sampling is providing samples of products for consumers. It is a time proven promotional method for exposing consumers to a new or improved product with the goal of generating repeat usage. Free product sampling is an important promotional method for exposing consumers to products. Product sampling is a universally accepted promotion tactic in the consumer packaged goods industry for supporting a new product launch or supporting an under-performing brand.

Product sampling is expensive because it includes processing customer orders, manufacturing costs, packing and shipping costs, distribution costs and fulfillment costs. These costs are called fulfillment costs because they are costs of fulfilling “orders” for product samples.

Fulfillment houses pack, prepare, and label samples for delivery through the U.S. Postal Service. Examples of fulfillment houses include Young America and NuWorld Marketing. Fulfillment house prices are generally based on U.S. Postage charges of size/weight and packing costs.

There are a wide variety of ways to distribute samples. They include direct mail, door-to-door, in-store distribution and delivery in Sunday “Free Standing Inserts” (FSI) newspaper sections. The cost of sampling is usually calculated on a cost per thousand (CPM) basis (e.g., $50/cpm). The cost is a function of the cost of the delivery method, the cost of obtaining identification data, and the cost of selecting identifications of people from that data for which samples will be sent.

There are several limitations and problems with today's sampling methods. First, due to limited information with which to effectively target distribution of samples to people, samples are often delivered to all consumers, rather than just to consumers that are most likely to want the product. Second, traditional packing and delivery methods are often prohibitively expensive. Third, obtaining feedback from the consumers that received the product samples regarding the effectiveness of the product sample promotion is often prohibitively expensive.

### SUMMARY OF THE INVENTION

Accordingly, an object of the present invention is to provide a novel computer network implemented method and system for sampling targeted customers and collecting post-sampling feedback.

Another object of the present invention is to provide a novel computer network implemented method and system for providing consumers product samples by registering consumers via an online service and providing consumers unique identifiers.

Another object of the present invention is to provide a novel computer network implemented method and system to more effectively target samples to customers by allowing customers to select which sampled products they will receive.

Yet another object of the present invention is to provide a novel method and system for comparing manufacturer sample product offers to consumer profiles and purchase history databases in order to target qualified consumers.

Still yet another object of the present invention is to provide a novel computer network implemented method and system to obtain quantitative and qualitative feedback of the effectiveness of product samples by monitoring the purchasing history of participating consumers subsequent to the delivery of the product samples.

These and other objects are achieved according to the present invention by providing a novel computer network implemented method and system for distributing product samples to consumers and monitoring consumer feedback including transmitting a signal prompting a user to provide profile data including identification of the user from a main computer over a computer network to a network address for the user's computer; transmitting the manufacturer's sample offer from the main computer over the computer network to the network address for the user's computer if the user's profile data meets criteria associated with a manufacturer's sample offer for a sample of a product; and delivering the sample of the product to an address for the user if the main computer receives a signal transmitted over the computer network indicating the user accepts the manufacturer's sample offer.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic illustration of a computer;

FIG. 2 is a schematic illustration of a computer network showing a plurality of personal computers, a communication system, and a central computer (e.g., a server);

FIG. 3 is a block diagram showing a method of distributing product samples and monitoring consumer feedback according to the present invention;

FIG. 4 is a block diagram showing a method of distribution according to a second embodiment of the invention; and

FIG. 5 is a block diagram showing a method of distribution according to a third embodiment of the invention.

### DETAILED DESCRIPTION OF THE PREFERRED EMBODIMENTS

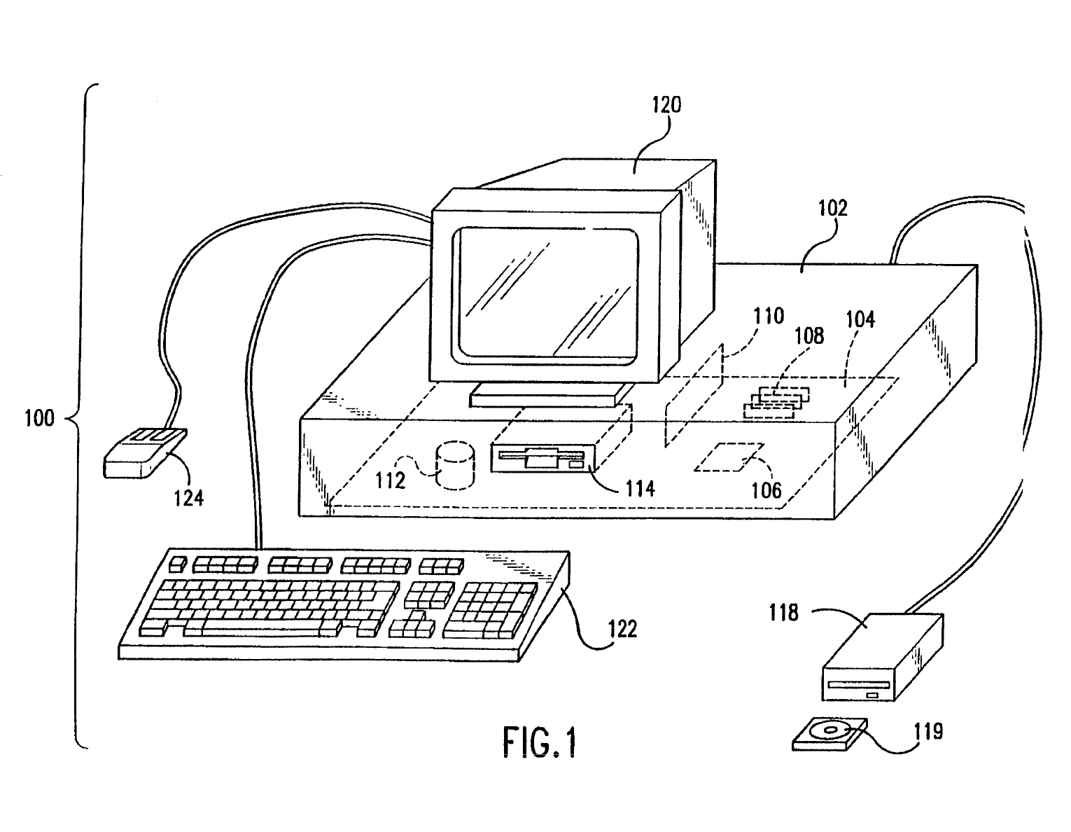

Referring now to the drawings, wherein like reference numerals designate identical or corresponding parts throughout the several views, and more particularly to FIG. 1 which shows a schematic illustration of a computer 100 including a computer housing 102 which houses a motherboard 104 which contains a CPU 106, memory 108 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 100 also includes plural input devices, (e.g., a keyboard 122 and mouse 124), and a display card 110 for controlling monitor 120. In addition, the computer 100 further includes a floppy disk drive 114; other removable media devices (e.g., compact disc 119, tape, and removable magneto-optical media (not shown)); and a hard disk 112, or other fixed, high density media drives, connected using an appropriate device bus (e.g., a SCSI bus, an Enhanced IDE bus, or a Ultra DMA bus). Also connected to the same device bus or another device bus, the computer 100 may additionally include a compact disc reader 118, a compact disc reader/writer unit (not shown) or a compact disc jukebox (not shown). Although compact disc 119 is shown in a CD caddy, the compact disc 119 can be inserted directly into CD-ROM drives which do not require caddies. Electronic communications between computer 100 and other systems may be performed by a suitably connected telephone line modem (not shown) or a network interface card (not shown).

As stated above, the computer 100 includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools.

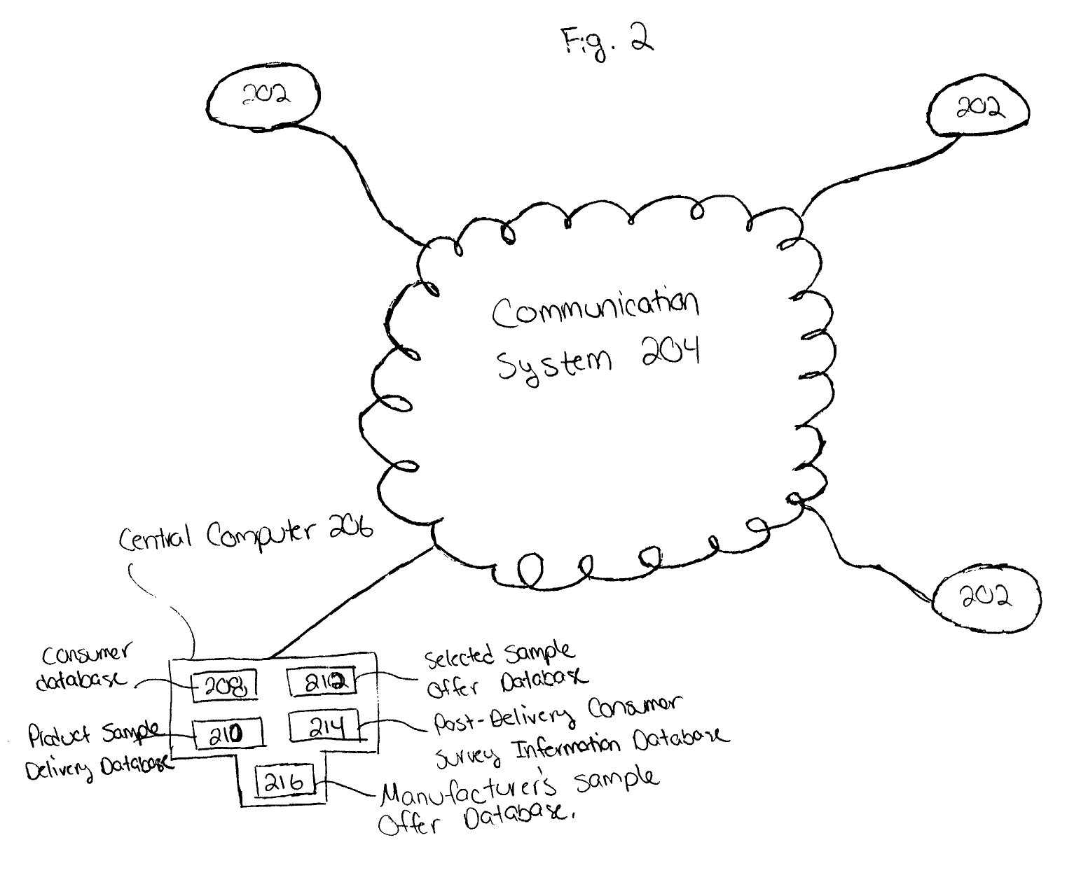

The computer network 200 of FIG. 2 includes the computers 100 (not shown) of a plurality of users 202, a communications system 204, and a central computer system 206 which also includes a computer such as computer 100. The methods of the present invention is implemented using the computer network 200, the central computer 206, and one or more of the computers 100.

The computer readable media of the central computer system 206 further includes the computer program product of the present invention for determining consumer conversion of product samples. The computer code devices of the present invention can be any interpreted or executable code mechanism, including but not limited to scripts, interpreters, dynamic link libraries, Java classes, and complete executable programs.

The communications system 204 could be a public telephone system, a cable system, or any system which provides a user access to the Internet, or a system which provides the user access to some other network of computers. The central computer system 206 includes means for accessing a consumer database 208, a product sample delivery database 210, a to selected sample offer database 212, a post-delivery consumer survey information database 214, and a manufacturer's sample offer database 216. The central computer system 206 could be a single computer operating as a server or could be a plurality of computers acting in a distributed environment.

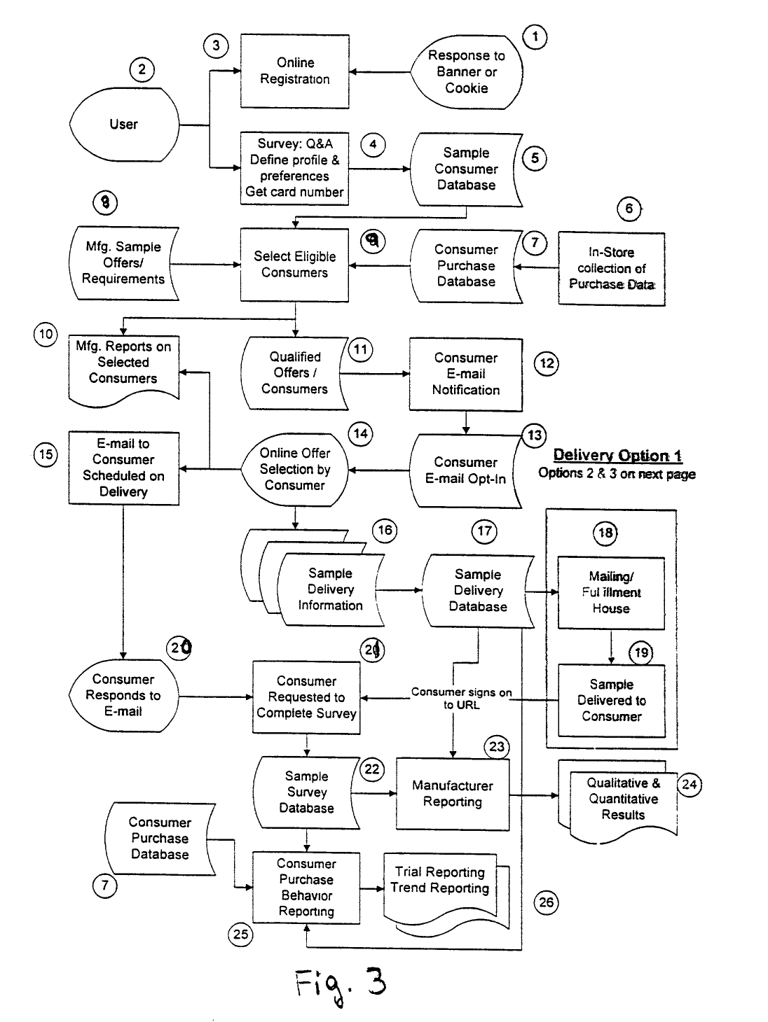

FIG. 3 shows a block diagram illustrating the computer network implemented steps of distributing product samples and monitoring user feedback according to the present invention. The steps shown in FIG. 3 are performed by the central computer system 206, a communication system 204 and at least one user 202 having a computer 100.

Step 1 illustrates a user 202 whose computer 100 is connected to the Internet responding to a banner advertisement or accessing a website having an online registration as shown in step 3. Thus, in step 1, user 202 is invited to register to participate in a sample product distribution program via data transmitted over the computer network 200. The user 202's computer interprets the data by displaying an invitation to register. In a preferred environment, the user 202 uses a personal computer 100 to access the communication system 204. Alternatively, the user may use a personal digital assistant, a cellular telephone, or a kiosk, instead of the personal computer 100 to connect to the communication system 204.

An invitation in the form of an online targeted banner, an e-mail message, or a web page could be communicated to the user. In the context of this invention, a banner is a section of a Web page containing an advertiser's advertisement and a link to the advertiser's Web site, an e-mail message is an electronic message directed to an e-mail address, and a web page is a display presented on a personal computer screen for viewing by a user 202 which contains text and images in accordance with instructions sent from central computer 206.

Step 2 illustrates that the user 202's computer 100 contacting the URL address for either the step 3 online registration or the step 4 online surveying in response to the user 202 entering the corresponding URL, instead of reaching the online registration site via step 1. Upon contacting the URL address for the online registration page, the user's computer 100 receives page data from the on-line registration site inviting the user 202 to register.

Step 3 illustrates the user's computer 100 accessing the online registration site on the Internet, and the user's computer 100 receiving page data informing the user 202 of product sample opportunities, participating rules, and privacy policies. During step 3, the user is invited to register. The user provides via data transmitted from her computer 100 various standard information including name, postal address, and e-mail address, when registering. Additional information that the user may provides includes occupation and occupation related information. Registration enables the central computer system 206 to periodically transmit data to the user 202's computer 100 notifying the user 202 when offers are available for which the user 202 qualifies.

In step 4, the user 202's computer 100 is instructed to display survey questions and transmit the user's answers to the questions. The survey answers provide profile type information including family size, ages of family members, pets, and home ownership status (i.e, whether they rent or own) and sample product preferences. The user 202 also enters his or her frequent shopper card number as part of this step.

In step 5, all the collected user registration data and survey information data is stored in a consumer database 208.

In step 6, the central computer 206 collects data describing purchases the user 202 makes from a participating store when the customer identifies himself or herself with a frequent shopper card during a purchase at a participating store or Internet based retailer. The user 202 presents his or her frequent shopper card in conjunction with making purchases from a participating retail store or Internet based retailer, which triggers collection of all product purchases. The frequent shopper card number is a unique identifier of a customer (user) which can be stored in association with a customer's shopping history so that the customer's shopping history can be subsequently analyzed in order to determine, inter alia, what product sample offers that customer qualifies for. A customer presents their shopper card at the point-of-sale of a participating retail store or provides the card number when conducting an online purchase. Product purchase information (e.g., universal product code (UPC) information) is captured and associated with the unique identifier and stored in the consumer database 208. In lieu of a shopping card, it should be understood that other means for uniquely identifying a customer and tracking a customer's shopping history are possible and also fall within the scope of this invention. For example, a credit card, personal check, drivers license, or the like can be used to uniquely identify a user.

In step 7, the central computer 206 accesses the consumer database 208 to analyze the actual buying behavior of a user 202 including, inter alia, the user's shopping history and purchase patterns. The consumer database 208 can be maintained and accessed by a single retailer or a combination of retailers. The consumer database 208 may be maintained by a third party.

In step 8, a manufacturer accesses the central computer 206 and maintains a manufacturer's sample offer database 216. A manufacturer either has a computer 100 and accesses the central computer 206 via the communication system 204 or the manufacturer alternatively accesses the central computer 206 directly. Alternatively, a manufacturer can supply product sample, qualification information and preferred delivery methods via a manual form, e-mail, facsimile, telephone or other offline method. The manufacturer's sample offer database 216 includes data of manufacturer's sample offers, qualification criteria data for user selection and the manufacturer's preferred delivery method.

In step 9, which follows after either step 5 or step 7, the central computer system 206 processes the qualification criteria for user selection (profile data) and the user purchase data stored in the consumer purchase database 208 independently or conjunctively to determine for which product sample offers, if any, a user qualifies. The central computer system accomplishes this by comparing sample offers and qualification criteria for the offers maintained in the manufacturer's sample offer database 216 to either the user's profile information stored in the consumer database 208 or purchase history information stored in the consumer database 208 or both. The purchase history stored in the consumer database 208 may include an identifier uniquely identifying the user in association with the dates of the user's purchases, the identifiers of the products purchased (typically the identifiers are UPC codes), the prices of the items purchased, the brands of the items purchased, and the total price of the purchase. The products purchased, their prices, and the total amount of each purchase may be stored in association with the date of purchase.

In step 10, the central computer system 206 generates manufacturer's reports which identify the selected users (consumers) qualified to receive each product sample.

In step 11, the central computer system 206 generates a selected sample offer database 212. Sample offer database 212 includes data of sample offers for each selected user. The central computer system 206 stores sample offer data in association with the identification of the user.

In step 12, the central computer system 206 generates and sends an e-mail to each selected user notifying them that they have qualified to receive sample products. The e-mail sent to the selected users invites them to a web page describing the corresponding product to samples. The e-mail may include a link to the web page. The selected users can access the Internet web page directly by entering the URL address of the site into the browser of their computer 100 or by clicking on a link included in the e-mail.

In step 13, the selected user has the option to indicate their interest (“opt-in”) in receiving the product samples by selecting the corresponding offers on a displayed web page or by e-mailing the central computer system 206 indicating their interest.

In step 14, the selected user is informed, by a message sent from the central computer system 206 to the selected user's personal computer 100, of available product samples and delivery method and instructions.

In step 15, the delivery method is determined by first determining if the manufacturer has specified a preferred delivery method or if the manufacturer will allow the user to choose from among choices in delivery methods. If the manufacturer allows the user a deliver method choice, the selected user selects a delivery method, the central computer system 206 schedules an e-mail to be transmitted by the central computer system 206 to the selected user. This transmitted e-mail notifies the selected user of the delivery instructions and schedule and further requests the selected user to respond via e-mail when the sample arrives.

In step 16, the central computer system 206 stores the information in the e-mails (from the users opting-in) transmitted to the central computer 206.

In step 17, the central computer system 206 generates a product sample delivery database 210 which includes all the requisite user information data provided by the users needed to deliver the product sample, which may include the user's postal address data and data indicating the user's preferred delivery hours.

Step 18 illustrates delivering the product samples to the users via standard U.S. mail, foreign country postal service or a third party delivery service. The sample delivery process is typically handled by a mailing/fulfillment company. The delivery instructions are preferably provided by the central computer 204 to the fulfillment company via transmission of an electronic file including the participating names and corresponding addresses.

In step 19, the delivery service delivers the product sample to the user's postal address, typically the user's residence address.

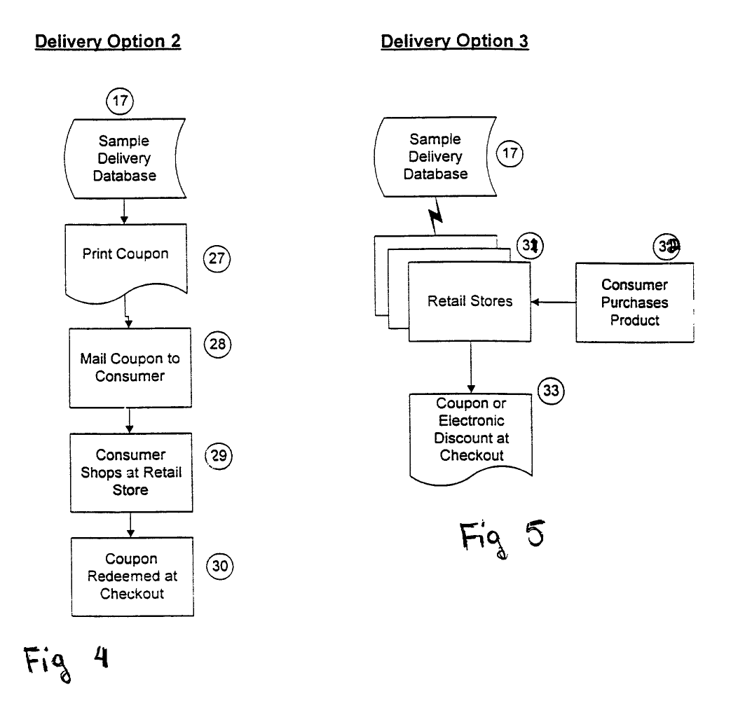

FIG. 4 is a block diagram illustrating a second method of product sample distribution. This method involves printing and redemption of coupons using the data in the sample delivery database 210.

In step 27, the central computer 204 instructs a printer or a plurality of printers (not shown) to print coupons to be distributed to the targeted users via the postal mail.

In step 28, the coupons are mailed to the targeted users at their postal address stored in the product sample delivery database 210.

In step 29, the targeted user can, upon receipt of the coupons, redeem the coupon at any participating store.

In step 30, the targeted user receives a discount for the total amount of the product identified in the coupon.

FIG. 5 shows a block diagram illustrating a third method of product sample distribution. Pursuant to this method, the central computer system 206 notifies selected users that they are eligible to pick up their product sample at a participating store by sending messages to the respective user's personal computers 100.

In step 31, an electronic file containing a record of all selected users, i.e., users who qualify to receive product samples is transmitted by the central computer system 206 to the computer of a store. The central computer system 206 transmits the file prior to the selected user arriving at the participating store.

In step 32, selected users visits the participating store and select the designated product. Selected users must present their shopper cards containing their unique identification and present the designated product at the point-of-sale. The designated product is identified uniquely identifiable, typically by a UPC code.

With reference again to FIG. 3, in step 20, the user 202 indicates with an e-mail message transmitted via their personal computer to the central computer system 206 that the product sample has been obtained.

In step 21, participating users are invited (encouraged) via an e-mail message transmitted by the central computer system 206 to the user's computer 202 to complete an online survey of their impressions regarding the product sample. Participating users can provide their feedback either by visiting the Internet site or by responding to the e-mail. The survey might include questions directed to the user's opinion of product quality, packaging, usability, etc. and questions directed to the likelihood of future purchases. Thus, not only are users exposed to new products and thus incented to purchase the sampled product in the future, but in addition to that, manufacturers can utilize the information obtained from the surveys regarding the product samples to determine if a different product would be a better subject of a sampling offer. The post delivery user survey is also an opportunity to begin a dialog with the user to determine which aspects of the product the user found appealing and which were not appealing. The positive and negative points raised in this survey may identify additional questions for future surveys or areas to explore in further dialog with the user who received the samples.

User feedback determined from this post delivery survey may also provide insight into potential problems with the packaging and delivery mechanism used to deliver the to sample product to the user. The survey may reveal that a large number of sampled products were damaged in shipment or that only a fraction of the product could be removed from the packaging. The survey data thus may be used to improve the sampling process itself as well as determine user attitudes towards the product.

Accordingly, in step 22, the central computer system 206 stores post-delivery user survey information data in database 214. Central computer system 206 utilizes the user survey information data to generate reports identifying users' opinions and suggestions regarding the sample product. The reports include both quantitative and qualitative data. The quantitative data reports include data such as how many samples of each type were delivered, how many users responded, etc. Quantitative data is used by the manufacturer to evaluate the effectiveness of the sampling program by identifying how many people requested and received the samples. The qualitative data reports include data such as product impressions and suggestions.

Moreover, subsequent to sample product delivery, the central computer system 206 processes the post-sampling product purchase data stored in user database 208 to determine post sampling buying behavior including consumer conversion and repeat product use. The central computer system 206 produces reports indicating buying trends (type and frequency) and trial conversion (i.e., brand switching).

Furthermore, post sampling product purchase data stored in database 208 and the post-delivery consumer survey data of database 214 can be analyzed to target users for future product sampling. By monitoring the participating user's post sampling product purchase data stored in database 208 and analyzing the consumer survey database 214, either conjunctively or separately, it is possible to determine users more likely to want a product and to distribute samples of the product to those users. Moreover, by delivering product samples only to users likely to want the product samples, the expense of packing and delivering product samples associated with the traditional manner of providing product samples is reduced.

Analysis of post sampling purchase data may also be used to identify users who did not subsequently purchase the sampled product or purchased other products in the same category as the sampled products. Identification of users who did not subsequently purchase the sampled product allows the manufacturer to start a dialog with that user, either in the form of e-mail or other communications, to determine why the user is not purchasing the product. Such a dialog may identify, for example, that the user likes the product but perceives the price to be too high. Analysis of post sampling purchase data will also allow the manufacturer to determine the effectiveness of the sampling program by determining the number of users that subsequently purchase the product that was sampled as opposed to other products in the same category.

Moreover, the consumer may be targeted for an incentive based upon the data stored in either or both of the post sampling product purchase database 208 and the post-delivery consumer survey database 214. Furthermore, identifying why the consumer did not by the product will allow the manufacturer to provide an incentive to the consumer based upon that result. For example, if the consumer indicates that the price was higher than a price of a competing product, the manufacturer may target that customer for a discount based upon the price differential of a competing product. Similarly, the manufacturer may obtain the consumer's preference for package size, shape, and provide an incentive targeted to the consumer based upon the consumer's preferred package style. The incentives can be communicated to the customer in a variety of ways, including via email messages, via a Web page, and via normal mail.

What is claimed as new and desired to be secured by Letters Patent of the United States is:

1. A computer network implemented method, comprising the steps of:
transmitting a signal prompting a user to provide profile data including identification of the user from a main computer over a computer network to a network address for the user's computer;
transmitting a manufacturer's sample offer from said main computer over said computer network to said network address for said user's computer if said user's profile data meets user profile criteria associated with a manufacturer's sample offer for a sample of a product; and
generating instructions for providing said sample of said product to said user if said main computer receives a signal transmitted over said computer network indicating said user accepts said manufacturer's sample offer.

2. The method of claim 1, further comprising the step of:
determining if said user's profile data meets said user profile criteria associated with said manufacturer's sample offer for a sample of said product.

3. The method of claim 1, further comprising the step of:
determining if said main computer receives said signal transmitted over said computer network indicating said user accepts said manufacturer's sample offer.

4. The method of claim 1, further comprising the step of:
determining if said user purchases said product.

5. The method of claim 1, wherein said transmitting said manufacturer's sample offer comprises the step of:
storing said profile data in a consumer database.

6. The method of claim 1, further comprising the step of:
transmitting a solicitation for feedback regarding said product from said main computer over said computer network to said network address for said user's computer.

7. The method of claim 1, wherein said step of transmitting a signal comprises:
transmitting a signal prompting said user to provide said user's postal mailing address.

8. The method of claim 1, further comprising the step of:
transmitting a record containing the postal mailing address of said user from said main computer to a network address for a third party.

9. The method of claim 1, further comprising the step of:
mailing a coupon discounting a full price of said sample to a postal mailing address of said user.

10. The method of claim 1, further comprising the step of:
mailing said sample to a postal address for said user.

11. The method of claim 1, wherein said step of delivering comprises:
transmitting an electronic discount or coupon to a point of sale terminal for the full price of said sample in a current transaction, if said main computer had received said signal indicating said user involved in said transaction had accepted said manufacturer's sample.

12. The method of claim 1, wherein said step of transmitting said manufacturer's sample offer comprises the step of:
sending email over the computer network to said user.

13. The method of claim 1, further comprising the step of:
storing said profile data and purchase data regarding a user's purchase in association with a unique identifier uniquely identifying said user in a consumer database.

14. The method of claim 13, further comprising the step of:
determining consumer conversion based at least in part on said purchase data stored in said consumer database.

15. The method of claim 13, further comprising the step of:
transmitting said manufacturer's sample offer from said main computer over said computer network to said network address for said user's computer only if said user's profile data meets said user profile criteria and said purchase history data meets purchase history criteria associated with said manufacturer's sample offer for said sample of said product.

16. A computer network system, comprising:
a main computer, said main computer configured:
to transmit a signal prompting a user to provide profile data including identification of the user from over a computer network to a network address for the user's computer;
to transmit a manufacturer's sample offer from said main computer over said computer network to said network address for said user's computer if said user's profile data meets user profile criteria associated with a manufacturer's sample offer for a sample of a product; and
to generate instructions for provide said sample of said product to said user in response to receipt of a signal transmitted over said computer network indicating said user accepts said manufacturer's sample offer.

17. The system of claim 16, further comprising;
means for determining if said user's profile data meets said user profile criteria associated with said manufacturer's sample offer for a sample of said product.

18. The system of claim 16, further comprising;
means for determining if said main computer receives said signal transmitted over said computer network indicating said user accepts said manufacturer's sample offer.

19. The system of claim 16, further comprising:
means for determining if said user purchases said product.

20. The system of claim 16, further comprising:
a consumer database storing said profile data.

21. The system of claim 16, further comprising:
means for transmitting a solicitation for feedback regarding said product from said main computer over said computer network to said network address for said user's computer.

22. The system of claim 1, further comprising;
means for transmitting a signal prompting said user to provide said user's postal mailing address.

23. The system of claim 16, further comprising:
means for transmitting a record containing the postal mailing address of said user from said main computer to a network address for a third party.

24. The system of claim 16, further comprising:
means for mailing a coupon for a free one of said samples to a postal mailing address of said user.

25. The system of claim 16, further comprising:
means for mailing said sample to a postal address for said user.

26. The system of claim 16, further comprising:
means for transmitting an electronic discount or coupon to a point of sale terminal for the full price of a sample in a current transaction, if said main computer had received said signal indicating said user involved in said transaction had accepted said manufacturer's sample.

27. The system of claim 16, further comprising:
means for sending email over the computer network to said user.

28. The system of claim 16, further comprising:
means for storing said profile data and purchase data regarding a user's purchase in association with a unique identifier uniquely identifying said user in a consumer database.

29. The method of claim 28, further comprising:
means for determining consumer conversion based at least in part on said purchase data stored in said consumer database.

30. The method of claim 28, further comprising:
means for transmitting said manufacturer's sample offer from said main computer over said computer network to said network address for said user's computer only if said user's profile data meets said user profile criteria and said purchase history data meets purchase history criteria associated with said manufacturer's sample offer for said sample of said product.

31. A computer program product storing computer instructions for performing a network implemented method, said program comprising means for performing the steps of:
transmitting a signal prompting a user to provide profile data including identification of the user from a main computer over a computer network to a network address for the user's computer;
transmitting a manufacturer's sample offer from said main computer over said computer network to said network address for said user's computer if said user's profile data meets user profile criteria associated with a manufacturer's sample offer for a sample of a product; and
generating instructions for providing said sample of said product to said user if said main computer receives a signal transmitted over said computer network indicating said user accepts said manufacturer's sample offer.
